(19) United States
(12) Patent Application Publication
(10) Pub. No.: US 2013/0187775 A1
(43) Pub. Date: Jul. 25, 2013

(54) SYSTEM FOR MONITORING INFECTION CONTROL AND PREVENTION PROCESSES

(71) Applicants: Randal J. Marsden, Edmonton (CA); Steve Hole, Edmonton (CA)

(72) Inventors: Randal J. Marsden, Edmonton (CA); Steve Hole, Edmonton (CA)

(73) Assignee: Cleankeys, Inc., Edmonton (CA)

(21) Appl. No.: 13/747,469

(22) Filed: Jan. 22, 2013

Related U.S. Application Data
(60) Provisional application No. 61/589,293, filed on Jan. 20, 2012.

(51) Int. Cl. G08B 21/18

(52) U.S. Cl. CPC G08B 21/18
USPC 340/540

(57) ABSTRACT

The present invention is a centralized system for the automated monitoring and reporting of compliance to infection prevention policies. It is focused on the proactive reduction (elimination) of pathogenic organisms causing infection within the facility by enforcing best practices for infection prevention.

### PRIORITY CLAIM

This application claims the benefit of U.S. Provisional Application Ser. No. 61/589,293, filed Jan. 20, 2012, the contents of which are hereby incorporated by reference.

### FIELD OF THE INVENTION

The invention relates to a system that collects infection prevention data from a set of sensor packages distributed throughout an organization. Sensor package data includes a variety of specific sensor types that measure both contamination, cleaning and sterilization activities within the organization.

### BACKGROUND OF THE INVENTION

Healthcare-acquired infections (HAI) result in over 100,000 deaths every year in North America, making it one of the leading causes of death. Most of these infections occur because of the transfer of infectious agents through shared human contact with contaminated surfaces, devices and tools within the healthcare facility. While infection control practices and processes exist to reduce the spread of infection, they are often ineffective because of a lack of compliance and simple human error.

Many pathogenic organisms have adapted to antibiotic medications and disinfectants to the point that it is very difficult to kill or contain them—especially in healthcare facilities. Examples of such organisms include Methicillin-resistant Staphylococcus Aureus (MRSA) and Clostridium Difficile (C Diff), both of which have become deadly problems in hospitals.

In an effort to contain outbreaks of infections caused by these pathogenic organisms, technology has been developed to provide early detection of infections. U.S. Pat. No. 7,230,529 (Ketcherside et al) describes a computer program that interfaces a clinical information system with an expert system to determine when infections are occurring within a healthcare facility. For example, the program scans examination notes entered by an attending physician, pharmaceutical orders, and a patient's vital statistics, which it then correlates using an expert rule set to determine if an infection is indicated. Often, these types of computer programs can detect an infection outbreak before a human can, saving time, money, and human suffering.

While these early detection solutions have important value, they can only help after an infection has already occurred. A better approach would be to stop the infection from happening in the first place. Many of these infections occur because of the transfer of pathogenic organisms through shared human contact with contaminated surfaces, devices and tools within the facility. Facilities have established infection prevention procedures aimed at reducing or eliminating the spread of the organisms. Unfortunately, these policies are not always effective due, in part, to a lack of compliance and simple human error.

Many studies have shown the spread of infectious disease can be caused by hand-born pathogens. One of the most effective activities in combating Hospital-Acquired Infections is simple hand washing. Further studies have shown compliance to hand washing policies is below 40% in most healthcare facilities. Yet other studies have shown a much higher rate of compliance with the process is actively monitored. It follows, then, that an automatic hand hygiene monitoring solution would be beneficial.

U.S. Pat. No. 7,293,645 (Harper) describes a simple system wherein a device containing hand sanitizer is worn by the user and a record is kept each time the user cleans their hands using the device. When the device is returned for refill of hand sanitizer, the data is stored and thus a record of compliance of each user is established. The system improves compliance by first, making it convenient to clean hands, and second, by assigning accountability to the user. The solution described by Harper is simple and low-cost. However, there is a delay in detecting non-compliance, which means the spread of an infection can occur before non-compliance is detected.

U.S. Pat. No. 7,770,782 (Sahud) describes an active monitoring system, which allows healthcare providers to monitor hand hygiene compliance that includes a data reader adapted to be worn by a healthcare provider. The system includes a portal trigger disposed at each door portal of a patient room, which activates the reader to record an entrance event when the provider enters the patient room. The system includes a dispenser trigger disposed at each cleaning dispenser having cleanser in or at the entrance of each patient room which activates the reader to record a dispensing event when the provider causes the dispenser to dispense cleanser, the reader having a display which displays a number of dispensing events and a number of entrance events. This approach provides real-time data and warnings when non-compliance occurs, thus reducing the risk of the spread of infection.

US Patent Application No. 20120112883 (Wallace) describes a similar system that uses a real-time location system (RTLS) to monitor the movement of staff and equipment through a hospital, and correlates that to infection control and infection prevention activities. The purpose of the system is to assess the risk of contracting an infection or the risk of exposure to an infection posed to an Entity (eg. Patient), such as, for example a person. Tracking risk is not the same as tracking compliance to infection prevention policies, which, if followed, inherently reduce risk.

There is significant value in infection prevention as compared to infection detection and control. The cost in time, money, and human suffering is significantly lower if an infection is prevented rather than treated. The many solutions described hereto are oriented either toward detecting and tracking an infection that has already occurred, or measuring compliance to one particular infection prevention activity only (i.e. hand washing). There is a need for a more comprehensive system that monitors and reports on all infection prevention activities.

### SUMMARY OF THE INVENTION

The present invention is a centralized system for the automated monitoring and reporting of compliance to infection prevention policies. It is focused on the proactive reduction (elimination) of pathogenic organisms causing infection within the facility by enforcing best practices for infection prevention.

It collects, summarizes and applies policy rules to data from a collection of sensor packages distributed throughout a healthcare facility. A sensor package is a hardware device consisting of one or more sensor types (eg. touch, vibration, chemical, temperature, fluid, pressure, particulate and others) with independent power and communication capabilities. Some sensor packages have additional capabilities for interacting with human operators, providing both human input and display functions.

For example, a checklist representing an infection prevention work flow is presented on a tablet computer. The user performing the infection prevention activities marks them as completed on the tablet computer and such information is immediately transferred to the centralized system. Portions of the checklist may be pre-filled by the system for activities that can be automatically monitored by sensors. For example, a room recently vacated by a patient in a hospital must be thoroughly cleaned and disinfected. The work flow for cleaning the room involves mopping the floor, wiping surfaces with a disinfectant, and changing the bed sheets. Sensors embedded in the floor and a computer keyboard found in the room automatically report to the system when they have been cleaned and those items are automatically checked as completed on the work flow checklist. The changing of the bed sheets, however, has no sensor to detect when it has been completed and must therefore be entered manually by the user performing the task. All these activities are reported in real-time to the centralized system.

The integration of both automatic and manual tracking of a work flow provides the opportunity for analytics to determine if the manually-entered data is reasonable. For example, the changing of the bed sheets is to take place between wiping the surfaces and mopping the floor in the room-cleaning work flow. The time stamps of wiping the surfaces and mopping the floor are automatically stored, with the latter being subtracted from the former. If there wasn't reasonable time allowed between these steps for the changing of the bed sheets then the system will detect that the changing of the bed sheets could not have occurred (even if a user manually entered the data saying it did).

Policy is enforced through use of a policy rule engine. The policy rule engine is an infection prevention expert system that uses a variety of artificial intelligence techniques including: a production rule engine, an automated learning system, and a business process management (work flow) engine. Policy rules are applied to collected sensor data to identify potential contamination events, issue notifications and initiate response protocols. It identifies long term trends within the facility, learning what the optimal responses are to contamination events based on human feedback to previous responses. Responses vary in complexity from simple notifications (alerts, messages, alarms etc.) to complex work flows that involve multiple resources and multiple steps to complete.

The system provides multiple levels of reporting detail to users operating in several different roles. As the system focuses on the facility, all reporting has both a spatial (location) and temporal (time) coordinate. Sensor packages and human participants (staff, patients, visitors) may be continually tracked for location within the facility. The system seeks to direct response actions to resources in the specific location of occurrence in minimal time.

### BRIEF DESCRIPTION OF THE DRAWINGS

Preferred and alternative examples of the present invention are described in detail below with reference to the following drawings:

FIG. 1 is an exemplary system formed in accordance with an embodiment of the present invention;

FIG. 2 is a software block diagram showing the hierarchical tiers of an infection prevention monitoring software system;

FIG. 3 is a hardware block diagram showing the typical hardware components of a cleanable touch surface and sensor; and

FIGS. 4A through 4C show a flow diagram of an exemplary process performed by the system shown in FIG. 1.

### DETAILED DESCRIPTION OF THE PREFERRED EMBODIMENT

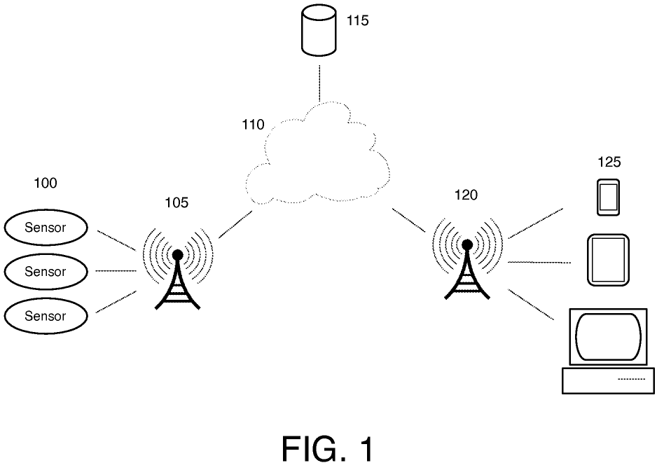

FIG. 1 shows a simple concept diagram representing the hardware components of a preferred embodiment of the present invention. A variety of sensors 100 are placed throughout the facility. These sensors detect compliance to infection prevention activities. Examples of sensors are include, but are not limited to the following: surface cleaning detection, UV light, laundry detergent, floor cleaning detergent, disinfecting liquid, manual workflow input device, hand washing, autoclave sterilizers, whole-room fogging gas, other liquid, particulate, humidity, temperature, motion, vibration, and air filtration sensors.

The sensors 100 connect to a network via a network interface 105. Data from the sensors is communicated to a network storage device 115 located in network (or “cloud”) 110. The network 110 may be closed or open. Sensor data is accessed by human interface devices 125 (eg. Desktop computer, notebook computer, tablet, smartphone, personal digital assistant, and so on) which connect to the network 110 via a network interface 120. Software running on the human computer interface devices 125 performs analysis of the sensor data.

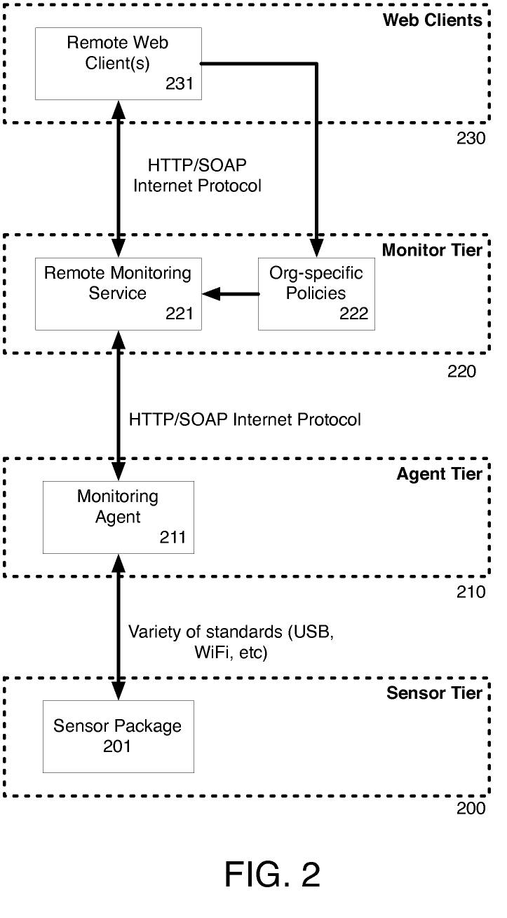

FIG. 2 shows a preferred embodiment of the communication layers and protocols encompassing the sensors and software running on the human computer interface devices 125. The system consists of three hierarchical levels of components. The Monitor tier 220 is a centralized software application service that provides an Internet accessible application protocol interface for communication. The Agent tier 210 is a collection of host hardware devices running Monitoring software 211 responsible for communicating between Sensor Packages 201 and the Remote Monitoring Service 221. Host hardware can be a dedicated (purpose built) host device or a general personal computer (desktop PC, laptop, tablet or smart phone). The Sensor tier 200 is a collection of SensorPackage 201 hardware devices that connect to and communicate with a Monitoring Agent 211.

Organization-specific Policies 222 reside at the Monitor Tier level. These policies define the infection prevention activities that must be conducted within an organization, and are customizable. These Policies feed into the Remote Monitoring Service 221, which is where the analysis of the sensor data takes place. Remote Web Client(s) 231 are located on the Web Clients layer 230. Here, the data may be remotely viewed and policies edited. A more detailed description of the three hierarchical levels follows.

Multiple Tenant Central Monitoring Service

The service is provides support for multiple “tenant” organizations, each with their own independent operating environment, security zone and data. Tenants are not visible to each other or to any external agency other than themselves. Each tenant appears to be an independent operating, standalone instance of the ICMS Monitor application service.

The service can be run in a centralized Software-as-a-Service mode or in Enterprise mode. Software-as-a-Service mode executes the Monitor in an Internet-wide accessible location, supporting multiple owner organizations each with their own tenant configuration. Enterprise mode executes the Monitor within the confines of the owner organization facility and a single tenant configuration. Enterprise mode installations are generally isolated from the general Internet and are not publicly visible or accessible.

The monitor provides the following capabilities:

Collection of contamination and infectious agent data from a variety of remote sensor devices deployed throughout a monitored site.

Presentation of summarized monitoring data via Web based user interface.

Automated issuance of alerts and notifications based on rules, key performance indicators (KPI) and parametric thresholds.

Automated initiation of contamination and infection resolutions actions and work flows.

Presentation of summarized sensor data via embedded “dashboard” interface.

Detection of (potential) contaminants based on collected sensor values.

Detection of cleaning activities and quality based on policy rules.

Policy Compliance Monitoring

Policy compliance monitoring makes use of a sophisticated policy rule engine that applies policy rules in priority order to collected sensor data as it is received by the monitor. Other embodiments may choose to process collected data after it has been received on a scheduled or periodic basis.

Policy rules are maintained and stored on an independent basis. They are assembled into one or more policy definitions that are applied to data in a priority order. One or more policy definitions may be enabled for processing for any type of data. For example two independent policy definitions are applied to input sensor data, three independent policy definitions are applied to contamination events.

Policy rules and definitions may include parameters. Parameters identify values referenced in the policy used in comparisons, expressions or limits. For example, a “threshold” parameter may define an integer value that when compared to an input sensor data value causes the rule to assert true and be applied by the rule engine.

The system supports authoring, managing and applying policy definition based on catalogues of policies defined as best practices. Catalogues provide support for government or regulator body policy compliance in the form of a published policy.

Spatial and Temporal Reporting

The system maintains a hierarchical spatial mapping (geospatial) system that ties graphical location images (maps, pictures) to specific spatial coordinates. It also provides the means to assign SensorPackage and SensorAgent devices to specific locations for notification and response action processing.

The system maintains a central time clock used to synchronize data collection and response action processing. Response actions to potential infection events are very time critical and require the ability to re-route actions based on time expiration policies.

The system provides an integrated location/time reporting capability that allows multiple events and associated responses to be displayed graphically to management role uses.

Participant Focused Work Flows

The system supports initiation of complex work flow (business processes) activities in response to any policy generated event type. Work flows include both automated and manual (human) activities, applied in a specific order.

Policy, Procedure and Compliance Training Management

The system records, directs and manages the training of personnel in infection prevention and monitoring processes.

Sensor Package Decoupling

The system provides support for loose coupling of SensorPackage devices to the set of managed devices. SensorPackages implement a mandatory probe function in their communications interface that allows SensorAgent software to probe for and identify SensorPackage devices within their operating range. The interface is independent of the underlying physical communications technology in use between SensorPackage and SensorAgent devices e.g. wireless (IEE 802.11, Zigbee, Bluetooth), USB, serial and others. Providers of SensorPackage devices must also provide a SensorAgent Probe implementation which is dynamically loaded and used by the SensorAgent software to identify and communicate with the SensorPackage.

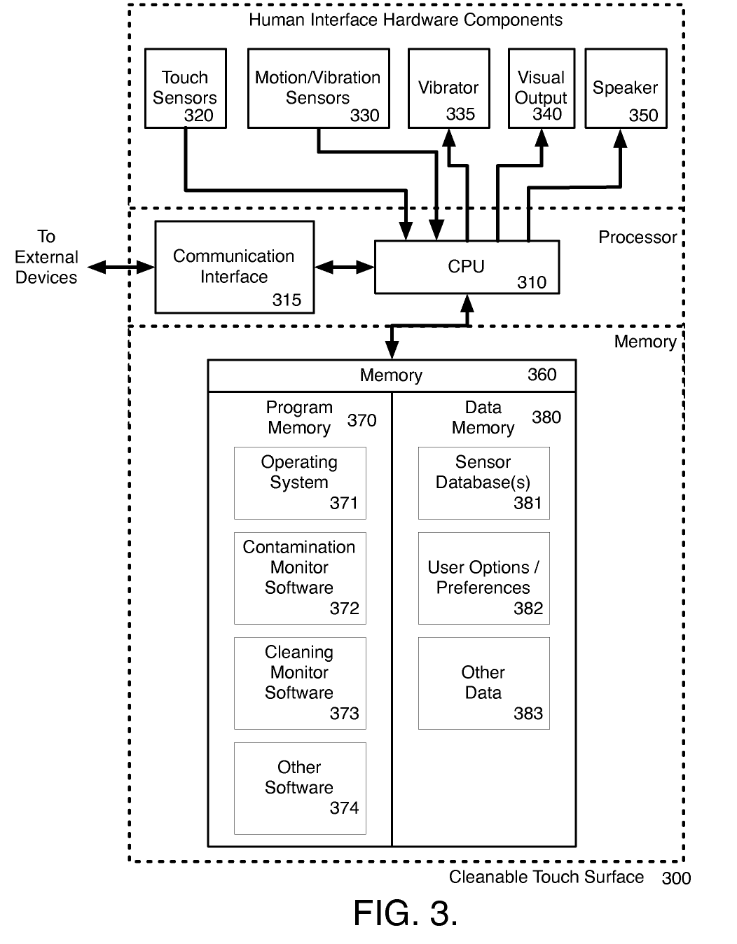

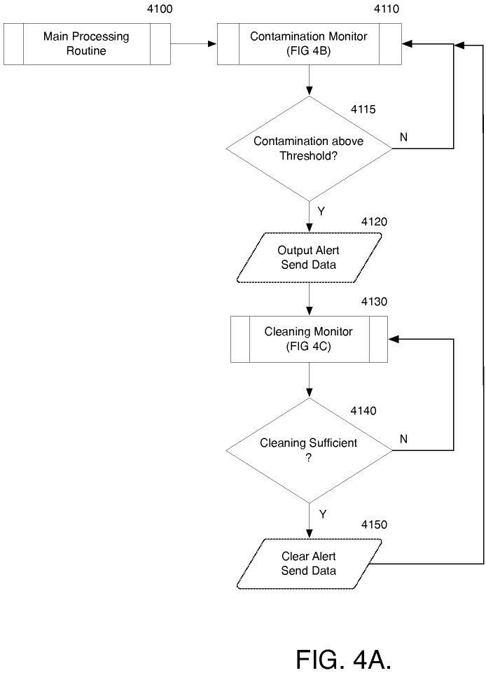

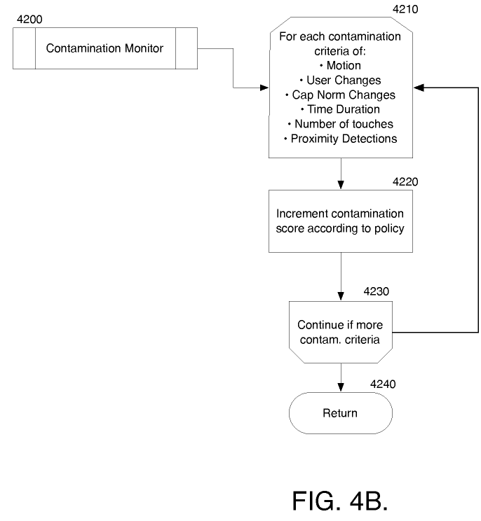

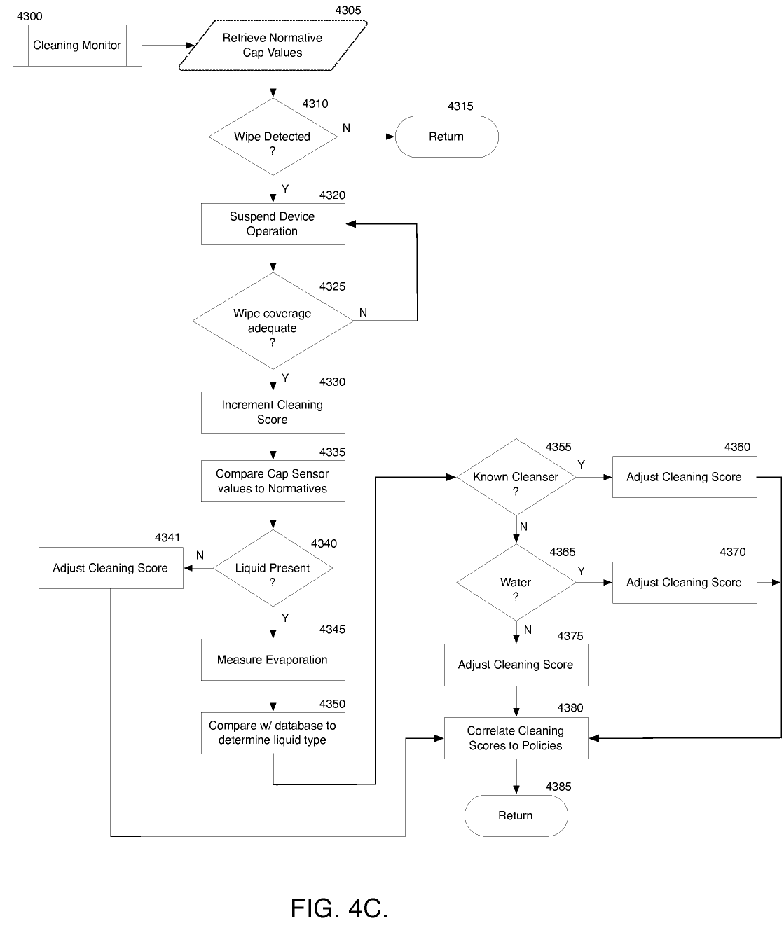

Studies have shown that common-touch surfaces, such as computer keyboards, are among the most contaminated surfaces in healthcare facilities. It follows then, that common-touch surfaces could have sensors built-in that detect compliance to cleaning policies and thus become one of many sensors reporting data in the system of the present invention. The apparatus shown in FIG. 3 and the corresponding process shown in FIGS. 4A-C show an exemplary apparatus of a touch surface that is just one part of the present invention shown and described in FIG. 1 and FIG. 2.

FIG. 3 shows a simplified block diagram of the hardware components of a typical device 300 in which the System and Method for a cleanable touch surface is implemented. The device 300 includes one or more touch sensors 320 that provides input to the CPU (processor) 310 notifying it of contact events when the surface is touched, typically mediated by a hardware controller that interprets the raw signals received from the touch sensor(s) and communicates the information to the CPU 310 using a known communication protocol via an available data port. Similarly, the device 300 includes one or more motion (or vibration) sensors 330 that communicate with the CPU 310 when the surface is tapped, in a manner similar to that of the touch sensor(s) 120. The CPU 310 communicates with a hardware controller for a visual output 340 to send user alerts. A speaker 350 is also coupled to the CPU 310 so that any appropriate auditory signals can be passed on to the user as guidance. A vibrator 335 is also coupled to the CPU 310 to provide appropriate haptic feedback to the user. The CPU 310 has access to a memory 360, which may include a combination of temporary and/or permanent storage, and both read-only and writable memory (random access memory or RAM), read-only memory (ROM), writable non-volatile memory such as FLASH memory, hard drives, floppy disks, and so forth. The memory 360 includes program memory 370 that contains all programs and software such as an operating system 371, contamination monitor software 372, cleaning monitor software 373, and any other application programs 374. The memory 360 also includes data memory 380 that includes a sensor database(s) 381 required by the contamination monitor software 372 and the cleaning monitor software 373, storage for maintaining a record of user options and preferences 382, and any other data 383 required by any element of the device 300. The CPU 310 may send information related to the contamination levels and cleaning status of the cleanable touch surface 300 to external devices or controllers by communicating through a standard communication interface 315.

FIGS. 4A through 4C show a process flow chart of an exemplary process performed by the contamination monitor software 372 and the cleaning monitor software 373. The flowcharts shown in FIGS. 4A to 4C are not intended to fully detail the software of the present invention in its entirety, but are used for illustrative purposes.

FIG. 4A shows a flow chart of the Main Processing Routine 4100 performed by the contamination monitor software 372 and the cleaning monitor software 373. At block 4110 the process invokes a Contamination Monitor sub-routine (FIG. 4B) to determine the level of contamination on the surface. At block 4120 the system determines whether or not the contamination level exceeds a specified threshold. This threshold is a user-changeable variable that is typically defined via a software control panel or through a user interface provided by the device 300 and stored in user preference memory 382. If the contamination level has not exceeded the defined threshold, the process returns back to block 4110 to continue monitoring for contamination.

If the contamination threshold has been exceeded, the process moves to block 4120 where it outputs an alert according to administrator-defined policy. The alert can take many forms including, but not limited to: visual indicator displayed on the visual output 340 (e.g., display device or device configured to illuminate the touch surface) of the device 300, an audible alert output on the speaker 350, a haptic alert output by the vibrator 335, or data that is sent via the communication interface 315 to external monitoring devices or software.

After issuing an alert, the process moves to block 4130 (FIG. 4C) where it monitors for cleaning actions taken. In block 4140, the system decides whether or not cleaning has been sufficient. What is deemed sufficient by the cleaning monitor software 373 is defined by an administrator and stored as a user preference in the memory 382. If cleaning has not been sufficient, the process returns to block 4130 to continue monitoring for cleaning activities. If the cleaning is sufficient, the process moves to block 4150 where the alert is cleared (or stopped). The process then returns to the start and once again begins monitoring for contamination in block 4110.

FIG. 4B shows a flowchart of an exemplary process for determining the contamination levels. The routine begins at block 4200 and continues for each contamination criteria in block 4210. There are many factors determined by the CPU 310 based on sensor and/or other data that can contribute to the cleanable surface becoming contaminated. By way of example, these might include: how often the device incorporating the cleanable surface has been moved, the number of times a different user has used the device, changes to the normative values of the touch sensors, a passage of time, the number of times the surface has been touched, and the number of times a human was detected within the proximity of the device. This list is not intended to be exhaustive and it will be evident to anyone skilled in the art that other criterion for determining contamination exists. Each contamination criteria examined in block 4210 will contribute to a contamination score in block 4220 and the process repeats for each criteria in block 4230. Once all contamination criteria have been examined, the process returns with a contamination score at block 4240.

FIG. 4C shows a flowchart of an exemplary process for determining the cleaning levels of the touch surface. The routine begins at block 4300 and retrieves the stored baseline value(s) for the touch capacitive sensors. These are the normative signal levels registered by the sensors when they are dry and not being touched. In one embodiment, the CPU 310 dynamically updates these normative values over time, to adapt to any changes in environment, signal degradation, or other factors which may affect the sensor's signal. Touch capacitive sensors are particularly useful in this application since the signal registered by each sensor differs if the surface is wet or dry. Thus, they can be used to detect the presence of liquid. When the surface is wiped using a liquid, the moisture affects the capacitance of the surface uniformly. This provides a second means whereby the adequacy of the cleaning of the surface can be determined (in addition to wipe detection). If, for example, a user has wet fingers, only the areas they touch on the surface will be affected by the moisture while other areas that remain dry will not. This information can easily be used to determine the difference between touching with wet fingers and the surface being wiped uniformly with a liquid.

The system then watches for a wiping motion in block 4310. In one embodiment, the CPU 310 determines when the surface has been cleaned by a wiping action.

Wipe detection is particularly useful when a user initiates cleaning the surface but has forgotten to pause it first. If the system detects touches that are indicative of a wiping action, it can automatically suspend or pause the operation of the device. In one embodiment, the device has an explicit method for the user to select pause mode, which disables functionality to allow the surface to be cleaned. A user may forget or choose not to activate this mode before cleaning. To accommodate this circumstance, the CPU 310 detects a wiping motion as a moving cluster of adjacent touches occurring simultaneously. As that cluster of touches begins to move, the CPU 310 determines the action to be a wiping motion and functionality of the device is temporarily disabled, allowing the wiping motion to take place without the pause mode being manually activated.

If a wiping motion is not detected, the process exits at block 4315. If a wiping motion is detected, the system suspends operation of the device in block 4320. In block 4325 the CPU 310 determines if wipe coverage was adequate. For example, if only half of the touch surface was wiped, the CPU 310 automatically ascertains this and judges this wiping action to be an incomplete wipe.

In infection sensitive environments, the contamination on the surface may not be visible to the naked human eye. In fact, the most harmful pathogens are almost always invisible. In this circumstance, the user doesn't have the benefit of seeing where they have or haven't wiped by simply looking at the presence or absence of contamination. Further, many cleaning liquids are clear again making it difficult for a user to know if they have cleaned the entire surface adequately.

To assist with this problem, an embodiment of the cleanable surface incorporates a virtual visual representation of the surface on a display (either attached to the surface or on the screen of a connected computer (the visual output 340)). This visual representation, sometimes referred to as a “heat map”, changes the color of the virtual surface (or touch surface) wherever a touch occurs. Over time, the more the surface is touched, the more the virtual surface (or touch surface) becomes colored. As the user wipes the cleanable surface, the virtual surface representation provides feedback whereby the colorization is removed corresponding to where the wiping takes place. In effect, the user “erases” the coloring on the virtual surface by wiping the real surface. In this way, they are provided immediate visual feedback as to the adequacy of their wiping action.

Once the CPU 310 determines the wiping coverage is adequate, it increments a cleaning “score” in block 4330. The process continues to block 4335 where the CPU 310 compares the capacitive sensor values right after the wipe is completed with the baseline values retrieved in block 4305. A uniform difference between all the sensors as determined by the CPU 310 indicates the presence of a liquid on the surface as determined in block 4340. If no liquid is found to be present, the process adjusts the cleaning score accordingly in block 4341 and then proceeds to block 4380 where the cleaning score is compared with stored policy data. Policy data is typically defined by a facility administrator in which the device is being used. For example, a hospital may choose to have a policy that the surface must be cleaned with a liquid. If no liquid was used then the process would determine that the cleaning was not adequate. The policy data may reside onboard the device 300 in the data memory 382, or it may be stored external to the device and communicated via the communication interface 315

If liquid is detected in block 4340 the process moves to block 4345 where the CPU 310 measures the rate of evaporation of the liquid from the cleanable touch surface. It does this in an effort to determine the type of liquid used to clean the surface. Some policies, for example, may dictate that a certain type of cleanser or disinfectant be used while others may allow only water. The CPU 310 ascertains, to the extent possible, what type of liquid was used during the wiping action.

In one embodiment, the CPU 310 uses data from the capacitive sensors in the surface to determine the presence of moisture on the surface. Moisture changes the capacitance of the surface, and can therefore be detected using the touch capacitive sensors in the surface.

Further, as the liquid evaporates from the surface, the capacitance on the surface changes accordingly and can be detected by a change in capacitance of the surface's capacitive touch sensors. By measuring this change, the rate of evaporation is determined and correlated to various known cleaning liquids (such as water and alcohol). For example, the evaporation rate of alcohol is faster than that of water, and so the surface can tell the difference between water and alcohol. Thus, using the evaporation rates of the cleaning liquid, the CPU 310 can determine what type of liquid was used to clean its surface. The rate at which a liquid evaporates is stored as “evaporation signatures” in the data memory sensor database 381.

The rate of evaporation can vary even for the same liquid from environment to environment. For example, most liquids will evaporate slower in a humid, cool environment than they will in a dry, hot environment. To accommodate for this variability, an embodiment of the present invention allows the user to calibrate the surface for the liquid being used and the environment in which it is being used. They do this by putting the device into a “learn” mode and then coat the surface with the liquid. The system then records the rate of evaporation of that liquid in that environment and stores it in the sensor memory 370 for reference in block 4350 of FIG. 4C.

In another embodiment, a local humidity value is retrieved from a local or remote (e.g., website) source via the communication interface 315. The retrieved humidity value is then used by the CPU 310 to alter the stored evaporation rates.

The process determines whether or not the liquid is a known cleanser in block 4355 of FIG. 4C. If it is a known cleanser, it adjusts the cleaning score accordingly in clock 4360. If it is not a known cleanser then the CPU 310 determines if the liquid was water in block 4365, and then adjusts the score accordingly in block 4370 (for water) and block 4375 for not water. In the case of block 4375, it is an unknown liquid and a flag or warning can be issued prompting the user to identify the liquid and/or carry out a calibration so the CPU 310 can store the evaporation signature of the new liquid.

The process continues to block 4380 where the cleaning score is compared with policies stored in user preferences data 382, or alternatively retrieves the policy data from an external device via the communication interface 315. It should be noted that the term “cleaning score” is used simply for illustrative purposes, and that in reality a more complex set of rules make up the algorithm that determines whether or not the cleaning has been adequate and meets the requirements of the stored policies. The process then exits at block 4385.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system comprising:
at a processing device coupled via a network connection to a plurality of sensors that monitor compliance to infection prevention activities,
receiving data from a plurality of sensors that monitor compliance to infection prevention activities;
analyzing the received data based on one or more customizable policy; and
outputting at least one of a report or an alert based on the analysis.

2. The monitoring of compliance may be done by an automated process (example: Cleankeys).

3. The monitoring of compliance may involve manual interaction and input from humans (example: CleanSlate).

4. The solution can be implemented “in the cloud” or over a network.

5. The types sensors can be anything that monitors infection prevention activities and include, but is not limited to: surface cleaning detection, UV light sensor, laundry sensor, manual workflow input device, hand washing sensors, autoclave sterilizers, whole-room fogging gas sensors, liquid sensors, and air filtration sensors.
